(19) United States
(12) Patent Application Publication
(10) Pub. No.: US 2023/0055312 A1
(43) Pub. Date: Feb. 23, 2023

(54) ENVIRONMENT AGNOSTIC INVARIANT RISK MINIMIZATION FOR CLASSIFICATION OF SEQUENTIAL DATASETS

(71) Applicant: International Business Machines Corporation, Armonk, NY (US)

(72) Inventors: Vinod Muthusamy, Austin, TX (US); Praveen Venkateswaran, Irvine, CA (US); Vatche Isahagian, Belmont, MA (US)

(21) Appl. No.: 17/400,900

(22) Filed: Aug. 12, 2021

(51) Int. Cl. G06N 20/00; G06K 9/62

(52) U.S. Cl. CPC G06N 20/00; G06K 9/6265; G06K 9/6268

(57) ABSTRACT

A method of generating a model for classifying sequential data, the method including receiving the sequential data including records having features; initializing mask weights and classifier weights on the features; processing, iteratively, frames of the sequential data using the model comprising the mask and classifier weights, wherein at each iteration the processing includes generating a current one of the frames, computing a penalty term over a data space of the current frame, and updating the mask weights using the classifier weights on the features and the penalty term; and outputting the machine learning model including updated ones of the mask weights to a service for performing a classification task based on a detection of at least one of the features in test data.

### BACKGROUND

Machine learning models have been incorporated in multiple application domains. While the increased adoption has led to considerable success, there have been numerous examples of the brittleness of machine learning models in generalizing to Out-Of-Distribution (OOD) data. This is partly due to the conventional machine learning models being influenced by spurious correlations and data biases that fail to hold outside of training data distributions.

There has been an increasing effort to improve the generalization of these models to OOD data using different approaches like meta-learning, adversarial learning, feature representations, among others.

### BRIEF SUMMARY

According to an embodiment of the present invention, a method of generating a machine learning model for classifying sequential data is provided, wherein the sequential data comprises a plurality of records having a plurality of features in a plurality of environments. The method includes initializing a set of mask weights on the features; initializing a set of classifier weights on the features; processing, iteratively, a plurality of frames of the sequential data using the machine learning model comprising the mask weights and the classifier weights, wherein at each iteration the processing comprises: generating a current one of the frames of the sequential data; computing a penalty term over a data space of the current frame; and updating the mask weights using the classifier weights on the features and the penalty term; and outputting the machine learning model including updated ones of the mask weights to a service for performing a classification task based on a detection of at least one of the features in test data.

As used herein, “facilitating” an action includes performing the action, making the action easier, helping to carry the action out, or causing the action to be performed. Thus, by way of example and not limitation, instructions executing on one processor might facilitate an action carried out by instructions executing on a remote processor, by sending appropriate data or commands to cause or aid the action to be performed. For the avoidance of doubt, where an actor facilitates an action by other than performing the action, the action is nevertheless performed by some entity or combination of entities.

One or more embodiments of the invention or elements thereof can be implemented in the form of a computer program product including a computer readable storage medium with computer usable program code for performing the method steps indicated. Furthermore, one or more embodiments of the invention or elements thereof can be implemented in the form of a system (or apparatus) including a memory, and at least one processor that is coupled to the memory and operative to perform exemplary method steps. Yet further, in another aspect, one or more embodiments of the invention or elements thereof can be implemented in the form of means for carrying out one or more of the method steps described herein; the means can include (i) hardware mod-ule(s), (ii) software module(s) stored in a computer readable storage medium (or multiple such media) and implemented on a hardware processor, or (iii) a combination of (i) and (ii); any of (i)-(iii) implement the specific techniques set forth herein.

Techniques of the present invention can provide substantial beneficial technical effects. Some embodiments may not have these potential advantages and these potential advantages are not necessarily required of all embodiments. For example, one or more embodiments may provide for:

an environment-agnostic approach to training robust models/classifiers for sequential data needs no prior information about environments nor any segmentation;

an environment-agnostic approach to training robust models/classifiers, wherein the models/classifiers are generalized to OOD data, and are not influenced by spurious correlations;

application of a generalized model configured to detect a target; and

improve technological process of computerized machine learning by training models to be more robust to OOD data such that models trained using aspects of the invention produce more robust performance than prior art during the inferencing phase.

These and other features and advantages of the present invention will become apparent from the following detailed description of illustrative embodiments thereof, which is to be read in connection with the accompanying drawings.

### BRIEF DESCRIPTION OF THE DRAWINGS

Preferred embodiments of the present invention will be described below in more detail, with reference to the accompanying drawings:

FIG. 1 is a flow diagram of an environment-agnostic approach used to develop generalizable models for classification tasks in sequential datasets according to one or more embodiments of the present invention;

FIG. 2 is an algorithm for an environment agnostic sequential predictor, according to an aspect of the invention;

FIG. 3 is a table of exemplary hyperparameter ranges, according to an aspect of the invention;

FIG. 4 includes a pair of graphs showing of the relative sensitivity of EASP, IRMv1, and ERM to imperfect segmentation of data for a given dataset according to one or more embodiments of the present invention;

FIG. 5 is a flow diagram of an environment-agnostic approach used to develop generalizable models for classification tasks in sequential datasets according to one or more embodiments of the present invention;

FIG. 6 is a generalized system for classifying data using a model according to one or more embodiments of the present invention;

FIG. 7 depicts a cloud computing environment according to an embodiment of the present invention;

FIG. 8 depicts abstraction model layers according to an embodiment of the present invention; and

FIG. 9 depicts a computer system that may be useful in implementing one or more aspects and/or elements of the invention.

### DETAILED DESCRIPTION

The generalization of predictive models that follow the standard risk minimization paradigm of machine learning can be hindered by the presence of spurious correlations in the data. Identifying invariant predictors while training on data from multiple environments can influence models to focus on features that have an invariant causal relationship with a target, while reducing the effect of spurious features. Such invariant risk minimization approaches rely heavily on clearly defined environments and data being perfectly segmented into these environments for training. However, in real-world settings, perfect segmentation is challenging to achieve, and these environment-aware approaches prove to be sensitive to segmentation errors.

According to one or more embodiments of the present invention, an environment-agnostic approach is used to develop generalized models for classification tasks in sequential datasets, without needing prior knowledge of environments. In a sequential dataset, records are data items that are stored in order by some measure, for example, by timestamp. For example, to retrieve the tenth item in the data set, the system must first pass the preceding nine items. According to example embodiments of the present invention, the environment-agnostic approach results in models that can generalize to OOD data and that are not influenced by spurious correlations. For example, considering the case of training data consisting of images of cows in pastures and camels in the desert (e.g., labeled as “cow” and “camel”), a conventionally trained model will fail when the environments or backgrounds are switched in subsequent test data because the model is influenced by spurious correlations (i.e., green pastures with cows and sandy deserts with camels). A model trained according to one or more embodiments of the present invention is configured to rely on the invariant features (i.e., the cows and camels themselves), and is invariant to the environment, such that the model properly identifies the images as including cows or camels. Accordingly, methods and models described herein are improvements on conventional techniques, and solve at least the technological problem of environment agnostic feature identification.

Invariant Risk Minimization (IRM) is a framework that takes a different approach to the problem of model generalization. It assumes that the training data comes from multiple environments and that features whose distributions vary across the environments in the training data are likely to also vary between the training and test datasets and hence should be treated as spurious correlations. IRM identifies these spurious features and learns robust predictors by exploiting the varying degrees of spurious correlations present in the environments. Examples of environments can include images taken from different geographic regions, sensor readings from different types of sensors, or loans processed by different departments. The goal of IRM is to find a data representation such that the optimal classifier over this representation is identical or invariant over the training environments.

While IRM approaches have resulted in predictors that are effective in OOD generalization over a variety of datasets, they suffer from two inherent weaknesses. First, they rely on the assumption that the different training environments are known a priori. Second, they require perfect segmentation of the training data into these environments. In practice however, it can be challenging to identify the individual training environments, and there can be errors in distinguishing data from different environments resulting in imperfect segmentation of data.

To demonstrate the sensitivity of IRM to imperfect segmentation, an available dataset was used, which included sentences and their binary sentiment labels divided into two training environments. In the two training environments, a punctuation mark (either a ‘!’ or ‘.’) is introduced as a spurious feature with an 80% and 90% correlation with each of the binary sentiment labels, respectively, and with a 10% correlation in the test environment. Any model influenced by the punctuation feature rather than the sentence while predicting the sentiment will perform well during training but perform poorly under test. To simulate imperfect segmentation of data into the training environments, a percentage of examples from the first environment were “incorrectly” assigned to the second environment.

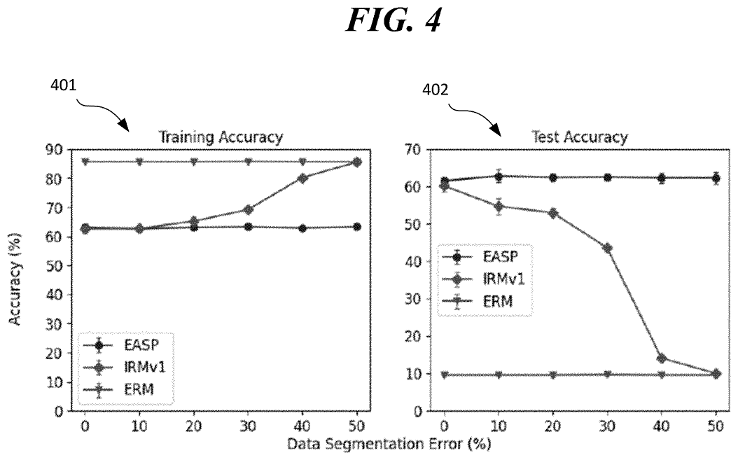

Referring to FIG. 4, with perfect data segmentation (e.g., 0% error), the IRM model is not influenced by the spurious feature correlation, and achieves good generalization, unlike the Empirical Risk Minimization (ERM) model. However, as the segmentation error increases, its accuracy drops significantly. The IRM model becomes heavily influenced by the spurious punctuation feature, as evidenced by the training accuracy (see graph 401) and low OOD test accuracy (see graph 402). It converges to the accuracy obtained by ERM when there is little or no difference in the spurious correlations between the two segmented environments, thus achieving poor generalization. Stated another way, the test accuracy (see graph 402) of IRM degenerates to about that of ERM when the training data cannot be segmented into environments.

The description above highlights the limitations of conventional environment-aware approaches. According to embodiments of the present invention, the difficulties in the setting of classification tasks for sequential data are addressed. Sequential data is prevalent in many application domains including time-series analysis, natural language processing, click-stream analysis, and business process mining. The data includes at least one sequential feature, and may also have other features such as metadata, customer information, etc., which can be spuriously correlated with the target variable. According to at least one example embodiment, an environment-agnostic approach to training robust models/classifiers for sequential data needs no prior information about environments nor any segmentation. The environment-agnostic approach exploits the structure of sequential data, and extends the IRM framework with a masking function that continually detects and gradually removes spurious features from the model during training, resulting in only the invariant features remaining. Accordingly, example embodiments of the environment-agnostic approach are improvements on the conventional environment-aware approaches.

Embodiments of the present invention include a framework is provided to develop an Environment-Agnostic Sequential Predictor (EASP) for classification tasks on sequential data, and formally prove the correctness of this framework.

Embodiments of the present invention ensure the generalization of EASP using a masking function that exploits the structure of sequential data and variances in spurious correlations to identify invariant features. According to some embodiments, weights associated with the spurious features exhibit more variance with a target variable compared to the invariant features, and a masking function is defined to capture a functionality of the invariant features in an improved prediction method.

A framework according to an example embodiment of the present invention outperforms IRM and ERM on a variety of sequential datasets from real-world domains, and demonstrates through extensive evaluations the significant advantage of EASP over those that require prior knowledge of the training environments.

The present application will now be described in greater detail by referring to the following discussion and drawings that accompany the present application. It is noted that the drawings of the present application are provided for illustrative purposes only and, as such, the drawings are not drawn to scale. It is also noted that like and corresponding elements are referred to by like reference numerals.

In the following description, numerous specific details are set forth, such as particular structures, components, materials, dimensions, processing steps and techniques, in order to provide an understanding of the various embodiments of the present application. However, it will be appreciated by one of ordinary skill in the art that the various embodiments of the present application may be practiced without these specific details. In other instances, well-known structures or processing steps have not been described in detail in order to avoid obscuring the present application.

Turning to a discussion of spurious and invariant data, consider a multi-environment sequential dataset including ε={e₁, . . . , eₙ} environments, each with a data distribution [symbol] ^{e} on X^{e}×Y^{e}, where X is the set of input features and Y is the target variable. The dataset contains at least one sequential feature X^{seq} ⊆X, where X^{seq}⊆ [symbol] ^{1×d}.

An invariant feature set X^{I} is one where the target prediction probability is consistent across all environments (e.g., p(Y|Xᵢ∈X^{I}, ε) is approximately constant). Conversely, the spurious feature set X^{S} includes features whose prediction probabilities vary across environments due to the presence of data biases. It follows that X^{I}•X^{S}=X, and X^{I}∩X^{S}=Ø, which states that a feature cannot be both invariant and spurious.

Given the foregoing, according to some embodiments, a risk function [symbol] ₑ(θ)= [symbol] ⁿ→ [symbol] is defined, which maps the model parameters θ to the expected loss on [symbol] ^{e} for a given loss function [symbol] :

[symbol]

ₑ(θ)= [symbol] ₍ₓ_{^{e}}_{,y}_{^{e}}₎˜ [symbol] (fθ(x),y) (1)

where x^{e}∈X^{e} and y^{e}∈Y^{e}, and [symbol] ᵢ refers to the risk or expected loss on the i^{th} environment.

The standard ERM approach attempts to minimize the average loss over all training examples in an environment agnostic manner:

[symbol]

_{ERM}(θ)= [symbol] _{(x,y)}˜∪_{e∈ε} [symbol] (fθ(x),y) (2)

While ERM has been shown to work well in practice for Independent and Identically Distributed (i.i.d.) data, it can fail when test environments and distributions differ significantly from training environments.

One instance of IRM searches for an invariant representation of inputs from different environments. The IRM principle states: “An invariant representation Φ(X) is one such that the optimal linear predictor w is the same across all environments eᵢ∈ε.” Finding the invariant predictor, w°Φ, may require solving the following bi-level optimization problem:

$${min}_{Φ , w} {\sum }_{e ∈ ℰ} {ℛ}_{e} ( {w}^{⊤} Φ ( {X}^{e} ) )$$

$$s . t . w ∈ {arg min}_{\tilde{w}} {ℛ}_{e} ( {\tilde{w}}^{⊤} Φ ( {X}^{e} ) ) , ∀ e ∈ ℰ .$$

However, since this optimization is highly intractable, particularly when Φ is non-linear, a tractable variant (IRMv1) has been proposed:

$${min}_{Φ} {\sum }_{e} {ℛ}_{e} ( Φ ( {X}^{e} ) ) + λ {‖ ∇ {}_{w} {ℛ}_{e} ( {w}^{⊤} Φ ( {X}^{e} ) ‖}_{2}^{2} \qquad ( 3 )$$

where the weights w are initialized to a vector of ones and λ∈[0, ∞) is a regularizer (regularizer weight) that balances between predictive power within an environment (ERM), and the invariance of the predictor across environments.

Another approach to determining whether the i^{th} feature Xᵢ is spurious or invariant, is to measure the stability of its parameter weight wᵢ. If Xᵢ is an invariant feature, wᵢ converges to a fixed magnitude, (i.e.) [symbol] [Y|Xᵢ] for some constant value, across all training iterations. Whereas if [symbol] [Y|Xᵢ] is changing, wᵢ would keep changing as well, and hence spurious features have parameter weights that exhibit high variance. This definition is equivalent to learning features whose correlations with the target variable are stable.

Example embodiments of the present invention leverage the determination of spurious or invariant data in the development of an EASP for sequential data. According to some embodiments, in the development of an EASP for classification tasks on sequential datasets no prior information about environments nor any segmentation.

Many conventional methods rely on the assumption (Assumption 1) that a sequence classification task has a non-empty set of sequential features X^{seq}⊆X that is predictive of the target variable and is hence invariant with respect to the target Y.

According to some embodiments, in the development of an EASP for classification tasks, there is no assumption on the degree of invariance, and no assumption on whether other features are invariant or spurious. According to at least one example embodiment of the present invention, an environment-agnostic approach to training robust models/classifiers for sequential data needs no prior information about environments nor any segmentation, and produces an improved generalized model, even when Assumption 1 does not hold, and the sequence feature is not predictive.

According to embodiments of the present invention, based on the determination of spurious or invariant data, spurious features have weights that exhibit high variance, and a masking function g(X) over X is defined. The function is configured to measure the variances of the feature weights while training over frames (mini-batches) of data instances of the sequential data, each frame including sampled inputs x and targets y, and gradually remove spurious features while retaining invariant ones. Formally:

$$g ( {X}_{i} ) \to \{ \begin{matrix}{X}_{i} & if {X}_{i} is invariant \\ 0 & if {X}_{i} is spurious\end{matrix} , ∀ {X}_{i} ∈ X \qquad ( 4 )$$

where g is a monotonic function and the image of g∈[0,1]. Note that the IRMv1 representation in equation (3) is equivalent to having the identity function [symbol] as a mask over Xe^{x}, i.e., Φ( [symbol] (X^{e})).

According to some embodiments, a frame size, or the size of an individual mini-batch, can depend on factors including model performance and the available compute resources, for example, to ensure that the data fits in the available memory. According to one or more embodiments, in the case where the sequential data is stored in order by timestamp, the frame can be a variable size determined based on a function, an absolute number (e.g., predetermined number) of data instances of the sequential data, or a number of data instances determined as a percentage of the total sequential data. One of ordinary skill in the art would recognize that other methods of creating frames can be implemented. Furthermore, the skilled artisan will be familiar with the concept of mini-batches from, for example, mini-batch gradient descent; a variation of the gradient descent algorithm that splits the training dataset into small batches that are used to calculate model error and update model coefficients.

According to some embodiments, the variance of the weights of each feature Xᵢ∈X are measured using a set of masks M={m₁, . . . , mₖ}, mᵢ∈ [symbol] , where k is the number of features in X The masks are updated with two objectives: (a) Use the variances to emphasize invariant features and suppress spurious ones, and (b) Exploit the sequential structure and invariance of X^{seq} based on Assumption 1. During each training epoch (i.e., one complete pass of a current frame through the algorithm), update the masks as:

mᵢ←mᵢ+μ(ν(w))−α(ν(wᵢ)),∀mᵢ∈M (5)

where μ(ν(w)) is the average variance observed over all features in X, ν(w₁) is the variance of the weights of feature Xᵢ, and hyperparameter a is a scaling factor. According to example embodiments of the present invention, the masks of invariant features gain in value over the training epochs since their variance ν(w₁) is low. Masks of spurious features on the other hand become negative, since the variance of their weights, coupled with the scaling factor is larger than the average, which is brought down by invariant features. The second objective is achieved by updating the masks M^{seq} of X^{seq} as:

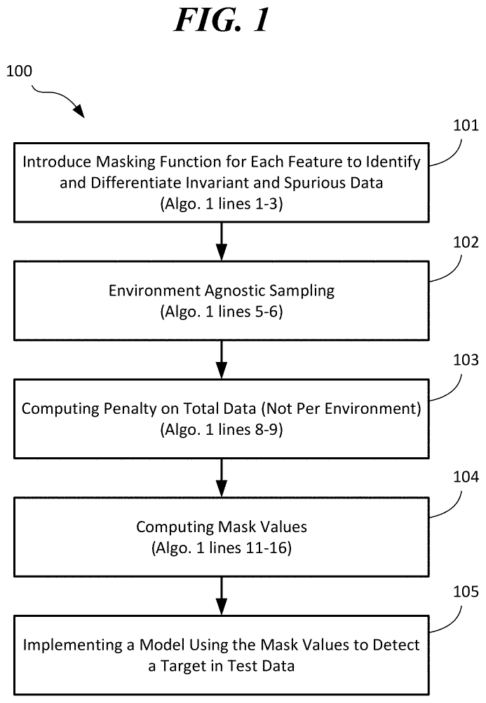

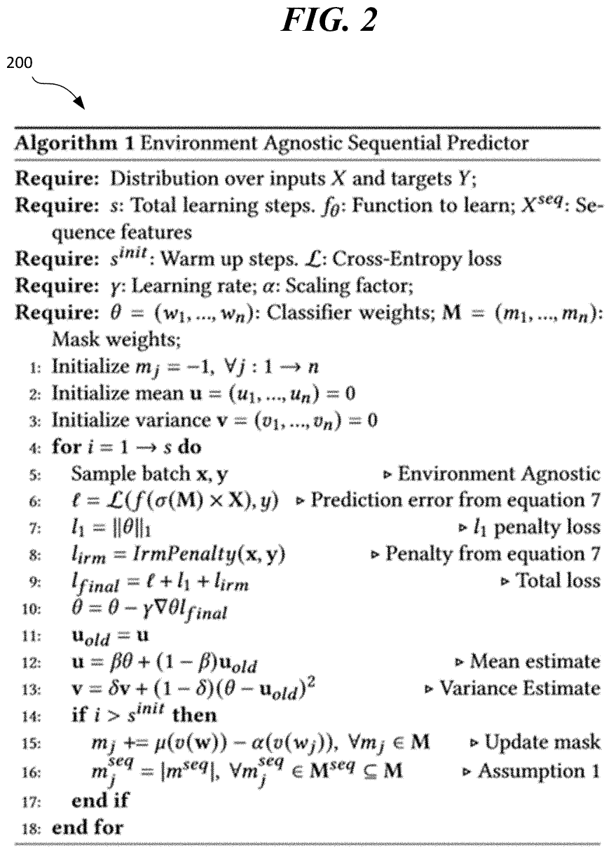

mᵢ^{seq}←|m^{seq}|,∀mᵢ^{seq}∈M^{seq}⊆M (6)

where |⋅| is the absolute function, which exploits Assumption 1 and ensures the invariance of X^{seq}. The degree of invariance is still dependent on the magnitude of variance exhibited by the weights of X^{seq}. Since the values of M are unbounded, the masks are scaled by using the sigmoid function σ. Since the sigmoid function is bounded between [0,1], σ(M) satisfies equation (4). According to some embodiments, an environment agnostic sequential predictor Z is found by solving:

$${{min}_{Z} ℛ ( Z ) + λ ‖ ∇ {}_{w} ℛ ( {w}^{⊤} Z ) ‖}_{2}^{2} , s . t . Z = σ ( M ) ⊙ X . \qquad ( 7 )$$

where ⊙ denotes element-wise multiplication and σ(M)∈[0, 1]. According to an embodiment of the present invention, the penalty term balances the predictive power and invariance of the predictor over the entire training data, as opposed to over each training environment. According to an embodiment of the present invention, an environment agnostic sequential predictor (e.g., an example generalization method) is depicted in Algorithm 1 (see FIG. 2, 200) and FIG. 1.

FIG. 1 is a flow diagram of an environment-agnostic method 100 for developing generalizable models for classification tasks in sequential datasets according to one or more embodiments of the present invention. According to some embodiments, the method learns parameters of weight for each feature Xᵢ, determines how much to rely on each feature by finding invariant features, and adjusts a corresponding parameter of weight, the mask weight m, to rely more on invariant features. Referring to FIG. 1, a mask weight or masking function is introduced for each feature, such that each mask weight corresponds to one feature, which can be used to identify and differentiate invariant features from spurious features 101. (See also, Algo. 1, lines 1-3, where j is a counter of mask weights m.) The method includes an environment agnostic sampling 102 to generate a current frame (or current batch x, y) and compute a prediction error for the mask weights using a loss function (see also, Algo. 1, lines 5-6). According to at least one embodiment, the prediction error is a difference between an expectation (f(σ(M)×X)) and an actual outcome (y). According to some embodiments, the sampling 102 does not use environmental data in generating the frame. According to some embodiments, a regularization is performed at line 7, which stops the model from over-fitting on some data, and hence performing poorly on unseen data. According to at least one embodiment, the regularization can be an L1 regularization, which is computed in each step as a sum of the current model parameters/model weights. The method further includes computing a penalty on the current frame and computing a total loss 103 (see also, Algo. 1, lines 8-9). According to some embodiments, a step of a gradient descent is performed at line 10 updating a penalty term θ—herein, the determination/update of the penalty term θ is described in a larger context of Algo. 1, lines 7-10. The method includes s steps (dictated by the for loop in line 4), where s is an arbitrary number determined empirically. According to at least one embodiment, the penalty loss l₁/penalty term θ, is calculated over the entire data space of the current frame (including target and environmental data), without needing to specially process or filter environmental data or without needing segmentation information. According to some embodiments, environmental data refers to background data or data that is not directly associated with a target. The method further includes computing mask values 104 (see also, Algo. 1, lines 11-16, where i is a counter of data instance or frame). It should be understood that β and δ are hyperparameters that determine how much of an emphasis to place on the new value of mean and variance, respectively, compared to a previous or old value (e.g., how much to update the mean and variance). In line 12, β corresponds to the mean calculation, and in line 13, δ corresponds to the variance calculation. According to some embodiments, the hyperparameters can be determined empirically. According to some embodiments, the computation of the mask values includes updating mean and variance parameters of the classifier weights; see also, Algo. 1, lines 12-15, wherein the mean is updated using the penalty term at line 12, the variance is updated using an updated mean and the penalty term at line 13, and the variance is used to update the mask values at line 15. According to at least one embodiment, a model having the mask values is implemented to process to test sequential data and detect a trained target 105, while being agnostic to environment data in the test sequential data.

According to an embodiment of the present invention, the masking function and environment agnostic predictor Z in equation (7) result in a generalized model for OOD data. For example, consider a generalized model formulated as a minimax problem as shown in Theorem 1, the generalized model minimizes risk or loss using invariant features, even under an adverse test environment.

Theorem 1. Given a training environment eₜᵣ, and a test environment eₜₑₛₜ, the set of invariant features X^{I} is the saddle point of the following minimax problem

$${X}^{I} = {min}_{Z} {max}_{{X}^{I} , {X}^{S}} {ℒ}_{test} ( Z ; {X}^{I} , {X}^{S} ) ,$$

$$where Z = σ ( M ) ⊙ X ,$$

where [symbol] ₜₑₛₜ is the cross-entropy loss in the test environment, and X^{I}, X^{S}, denote the set of invariant and spurious features respectively such that X^{I}∪X^{S}=X, and X^{I}∩X^{S}=Ø (i.e., they are disjoint).

Proof. Every Z can be partitioned into invariant variables Z^{I} and non-invariant variables Z^{S} as:

Z^{I}=σ(M)⊙X^{I},Z^{S}=σ(M)⊙X^{S}. (8)

Consider a test distribution or environment where the set of spurious features X^{S*}* are not predictive of the output Y, and only the invariant features X^{I} are predictive of Y, i.e.:

p(Y|Z,eₜₑₛₜ)=p(Y|Z^{I},eₜₑₛₜ),p(Y|Z,eₜᵣ)=p(Y|Z^{I},eₜᵣ). (9)

Therefore,

$$\begin{matrix}{ℒ}_{test} ( Z ; {X}^{I} , {X}^{S *} ) = H ( p ( Y \vert Z , {e}_{test} ) ; p ( Y \vert Z , {e}_{tr} ) ) \\ {=}^{( i )} H ( p ( Y \vert {Z}^{I} , {e}_{test} ) ; p ( Y \vert {Z}^{I} , {e}_{tr} ) ) \\ {=}^{( ii )} H ( p ( Y \vert σ ( M ) ⊙ {X}^{I} , {e}_{test} ) ; p ( Y \vert σ ( M ) ⊙ {X}^{I} , {e}_{tr} ) ) \\ {=}^{( iii )} H ( p ( Y \vert {X}^{I} , {e}_{test} ) ; p ( Y \vert {X}^{I} , {e}_{tr} ) ) \\ = {ℒ}_{test} ( {X}^{I} ; {X}^{I} , {X}^{S *} )\end{matrix} \qquad ( 10 )$$

where H(⋅) is the cross-entropy loss function. In Eq. 10, step (i) is obtained from applying equation (9), step (ii) is obtained by applying equation (8), and step (iii) is due to the property of the masks from equation (4).

Recall that X^{S*} was assumed to be non-predictive of Y. However, in many cases, the spurious feature X^{S} would have some predictive power over Y in the training environment. Hence, from the definition of spurious features X^{S}, their biased influence on the model performance during training will lead to an increased loss in the worst case test environment:

$${max}_{{X}^{S}} {ℒ}_{t e s t} ( Z ; {X}^{I} , {X}^{S} ) \geq {ℒ}_{t e s t} ( Z ; {X}^{I} , {X}^{S *} ) . \qquad ( 11 )$$

Recall X^{I} denotes the set of invariant features, thus p(Y|X^{I}, eₜₑₛₜ) does not depend on X^{S}. Therefore,

$${max}_{{X}^{S}} {ℒ}_{t e s t} ( {X}^{I} ; {X}^{I} , {X}^{S} ) \geq {ℒ}_{t e s t} ( {X}^{I} ; {X}^{I} , {X}^{S *} ) . \qquad ( 12 )$$

By combining equations (10), (11), and (12), we have:

$${max}_{{X}^{S}} {ℒ}_{t e s t} ( Z ; {X}^{I} , {X}^{S} ) \geq {max}_{{X}^{S}} {ℒ}_{t e s t} ( {X}^{I} ; {X}^{I} , {X}^{S} ) . \qquad ( 13 )$$

The above formulation holds for all X^{I}. Hence, taking the maximum over X^{I} in equation (13) preserves the inequality,

$${max}_{{X}^{I} , {X}^{S}} {ℒ}_{t e s t} ( Z ; {X}^{I} , {X}^{S} ) \geq {max}_{{X}^{I} , {X}^{S}} {ℒ}_{t e s t} ( {X}^{I} ; {X}^{I} , {X}^{S} )$$

which in turn implies,

$${X}^{I} = {min}_{Z} {max}_{{X}^{I} , {X}^{S}} {ℒ}_{t e s t} ( Z ; {X}^{I} , {X}^{S} ) .$$

Embodiments of the present invention are applicable to sequential datasets spanning multiple application domains: natural language processing (NLP) (including multiclass NLP predictions), temporal sequences (including financial predictions, customer behavior based on customer clickstreams, predictions using sensor data sequences, etc.), business process mining (including processing loan applications, insurance claims, hospital records management, etc.), Human Activity Recognition (HAR) (for example, using smartphone accelerometer and gyroscope readings corresponding to six activities to detect walking, standing, sitting, etc.), binary sentiment analysis, etc. For example, in the case of NLP, text classification models learn from sequences of text (sentences, paragraphs, documents, etc.) and assign them into categories.

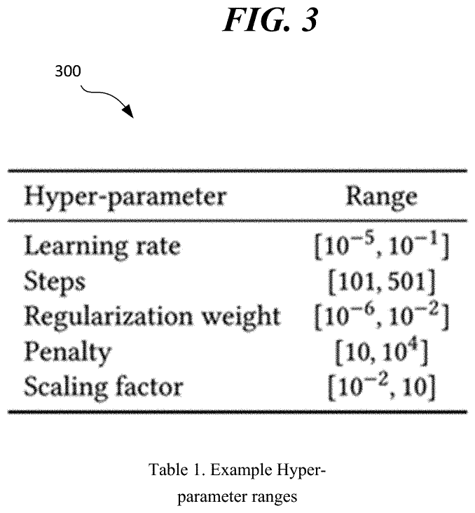

Hyper-parameters can be selected based on the application, for example, within the example values in Table 1 (see FIG. 3, 300—example hyper-parameter ranges). Different configurations can be selected to tune the performance.

Example embodiments of the EASP approach ignore spurious correlations and achieve improved accuracy while remaining environment agnostic, unlike IRMv1. This difference grows larger when there are data segmentation errors. Example embodiments of the EASP approach achieve improved Out-of-Distribution (OOD) accuracy.

Herein, the effectiveness of updating the mask of the sequence feature with |M^{seq}| has been shown. Selecting the right masks to update with the absolute function has an impact on the OOD test accuracy. Across all datasets, updating spurious feature masks with |M^{S}| results in low accuracies since the masking function considers them to no have some predictive power. Similarly, doing this for all features (|M|) does not perform as well as |M^{seq}| since the model is still influenced to some degree by the spurious features. Hence, using Assumption 1 exploits the sequential data structure to result in a model with improved generalization.

FIG. 4 includes a pair of graphs 401 and 402 showing of the relative sensitivity (measured in terms of accuracy) of EASP, IRMv1, and ERM to imperfect segmentation of data for a given dataset according to one or more embodiments of the present invention. In graphs 401 and 402 the quality of the data segmentation error in the training data has a range between 0-50%, where 50% segmentation is perfect segmentation. Graph 401 shows the training accuracy of the different modeling approaches and graph 402 shows the OOD test accuracy of the different modeling approaches.

As shown in FIG. 4, example EASP approaches are robust to spurious correlations irrespective of the degree of imperfect data segmentation in training environments. In an example case where a sequence feature is not predictive, example EASP approaches when Assumption 1 (i.e., there exists a sequential feature that is predictive of the target variable) does not hold, continue to be robust to the spurious correlation, and are therefore an improvement over ERM methods.

Example parameters for EASP include learning rate (e.g., between 0.005 and 0.05), scaling factor of 10, and regularizer weight (e.g., between 0.000001 and 0.0001), with a warm up of 50 steps. According to some embodiments, parameter values for any domain will depend on a structure of the model used, as well as the specific dataset.

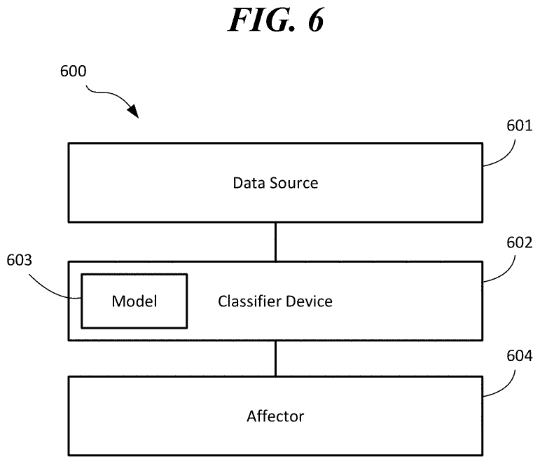

Applications of example embodiments described herein include general prediction and classification problems, such as outcome predictions exemplified by Service Level Agreements (SLA) for time, success, failure, etc., time prediction (e.g., time to complete, start time, etc.), etc. These and other applications would be apparent to one of ordinary skill in the art in view of the present disclosure. According to at least one embodiment, a generalized system 600 (see FIG. 6) includes a data source 601 of sequential data, such as a data store or device generating sensor data, a classifier device 602, such as a computer system confirmed to perform a classification task using a model 603, and an affector 604, configured to act on a classification output by the classifier device 602. The affector 604 can be, for example, a device configured to generate an alert, a database system configured to manage (e.g., publish, store, archive, delete, etc.) data according to the classification output, etc.

More particularly, a model generated according to one or more embodiments of the present invention can be implemented 105 as an improved document classification model, an improved sentiment classification model, an improved event detection model, etc. The improved sentiment classification model can be implemented by a processor (e.g., a particular computer or service) for classifying test data. For example, a document classification model can receive a text corpus of documents and process each of the documents, wherein the model adds (e.g., to metadata) an indication of a classification (e.g., world news, sports, business, science/technology) to each of the documents. For example, the method can include processing each of the documents using the machine learning model to identify instances of the features in each of the documents, classifying each of the documents according to respective ones of the identified instances of the features, and adding an indication of the respective classifications to each of the documents.

In another example, a sentiment classification model can receive a document, and process the document, wherein the model adds an indication of a sentiment to the document. For example, in a case where the classification is a sentiment classification and the sequential data includes a document, the method can include processing the document using the machine learning model to identify instances of the features in the document, identifying a sentiment for each of a plurality of portions of the document according to corresponding ones of the identified instances of the features, and adding an indication of the sentiments to the document.

In yet another example, an event detection model receives data from at least one sensor and processes the data received from the at least one sensor, wherein the model detects at least one event. In the case of an event detection model, the sensor can be an accelerometer, a gyroscope, etc., and the event can be, for example, a walking event (e.g., detecting a human walking using the accelerometer and the gyroscope of a device such as a smart-watch or smart-phone), a walking upstairs event, a walking downstairs event, a sitting event, a standing event, and a laying down event. Furthermore, models generated according to one or more embodiments of the present invention can also be used for improved image recognition, for example, as in the above-example of images of cows in pastures and camels in the desert, to be based on invariant features rather than spurious correlations.

It should be understood that embodiments of the present invention are applicable to modifying an existing model, thereby generating an improved model, and to generating new models (e.g., a newly instantiated model). In the case of an existing neural network model, for example, masks and mask weights determined according to some embodiments of the present invention can be used in combination with the weights of the existing neural network model. According to some embodiments, the mask weights are a vector that can be multiplied by the conventional weights, where the mask weights weight invariant features more heavily. Aspects of the present invention can be applied to any neural network model using, for example, a multiplication of the conventional model weights with determined masks/mask weights.

Recapitulation:

According to embodiments of the present invention, an environment-agnostic approach to identify invariant features and improve the generalization of deep learning models for classification of sequential datasets overcomes the inherent limitations of invariant risk minimization-based methods, which rely on prior knowledge of the different environments or sources of spurious correlations while training. According to at least one embodiment, a masking function is developed over input features, the masking function being configured to continually detect and gradually remove spurious features from a model during training, resulting in only invariant features remaining. According to some embodiments, the family of masking functions satisfying these conditions will minimize loss even under adverse test distributions. According to some embodiments, generated models can generalize to out-of-distribution data and perform competitively on a range of sequential datasets without the need for prior environment knowledge and perfect data segmentation.

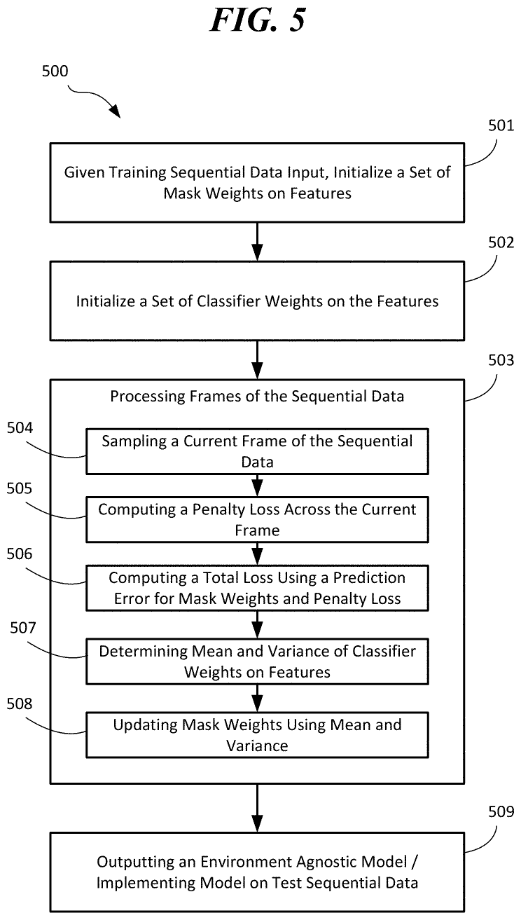

According to at least one embodiment of the present invention, a method 500 of generating a machine learning model for classifying sequential data (see FIG. 5), the method including receiving the sequential data, wherein the sequential data comprises a plurality of records having a plurality of features in a plurality of environments, and initializing a set of mask weights on the features 501; initializing a set of classifier weights on the features 502; processing, iteratively, a plurality of frames of the sequential data using the model comprising the mask weights and the classifier weights 503, wherein at each iteration the processing comprises: generating a current one of the frames of the sequential data 504; computing a penalty term over a data space of the current frame 505-506; and updating the mask weights using the classifier weights on the features and the penalty term 507-508; and outputting the machine learning model including updated ones of the mask weights to a service for performing a classification task based on a detection of at least one of the features in test data 509. According to some embodiments, the data space of the current frame is an entire data space of the current frame, and the method includes no assumption on a degree of invariance of the mask weights, and the machine learning model is one of an existing model and a newly instantiated model. According to one or more embodiments, computing the penalty term over the data space of the current frame further comprises: computing a penalty loss term over the data space of the current frame of the classifier weights across the current frame 505; and computing a total loss as a function of a prediction error for the mask weights on the features of the current frame and the penalty loss 506, wherein the method further comprises: determining a variance of the classifier weights on the features of the current frame 507, and wherein the updating of the mask weights increases the mask weights of invariant ones of the features according to the variance and/or decreases the mask weights of spurious ones of the features according to the variance.

The machine learning model can then be used to perform a variety of classification tasks.

According to some embodiments of the present invention, the method includes no assumption on a degree of invariance of the mask weights. According to some embodiments of the present invention, the sequential data is associated with the features and the method includes no assumption on whether each instance of a given one of the features is invariant or spurious in the sequential data, and the sequential data includes no labeled data about the environments.

It is understood in advance that although this disclosure includes a detailed description on cloud computing, implementation of the teachings recited herein are not limited to a cloud computing environment. Rather, embodiments of the present invention are capable of being implemented in conjunction with any other type of computing environment now known or later developed.

Cloud computing is a model of service delivery for enabling convenient, on-demand network access to a shared pool of configurable computing resources (e.g., networks, network bandwidth, servers, processing, memory, storage, applications, virtual machines, and services) that can be rapidly provisioned and released with minimal management effort or interaction with a provider of the service. This cloud model may include at least five characteristics, at least three service models, and at least four deployment models.

Characteristics are as follows:

On-demand self-service: a cloud consumer can unilaterally provision computing capabilities, such as server time and network storage, as needed automatically without requiring human interaction with the service's provider.

Broad network access: capabilities are available over a network and accessed through standard mechanisms that promote use by heterogeneous thin or thick client platforms (e.g., mobile phones, laptops, and PDAs).

Resource pooling: the provider's computing resources are pooled to serve multiple consumers using a multi-tenant model, with different physical and virtual resources dynamically assigned and reassigned according to demand. There is a sense of location independence in that the consumer generally has no control or knowledge over the exact location of the provided resources but may be able to specify location at a higher level of abstraction (e.g., country, state, or datacenter).

Rapid elasticity: capabilities can be rapidly and elastically provisioned, in some cases automatically, to quickly scale out and rapidly released to quickly scale in. To the consumer, the capabilities available for provisioning often appear to be unlimited and can be purchased in any quantity at any time.

Measured service: cloud systems automatically control and optimize resource use by leveraging a metering capability at some level of abstraction appropriate to the type of service (e.g., storage, processing, bandwidth, and active user accounts). Resource usage can be monitored, controlled, and reported providing transparency for both the provider and consumer of the utilized service.

Service Models are as follows:

Software as a Service (SaaS): the capability provided to the consumer is to use the provider's applications running on a cloud infrastructure. The applications are accessible from various client devices through a thin client interface such as a web browser (e.g., web-based email). The consumer does not manage or control the underlying cloud infrastructure including network, servers, operating systems, storage, or even individual application capabilities, with the possible exception of limited user-specific application configuration settings.

Platform as a Service (PaaS): the capability provided to the consumer is to deploy onto the cloud infrastructure consumer-created or acquired applications created using programming languages and tools supported by the provider. The consumer does not manage or control the underlying cloud infrastructure including networks, servers, operating systems, or storage, but has control over the deployed applications and possibly application hosting environment configurations.

Infrastructure as a Service (IaaS): the capability provided to the consumer is to provision processing, storage, networks, and other fundamental computing resources where the consumer is able to deploy and run arbitrary software, which can include operating systems and applications. The consumer does not manage or control the underlying cloud infrastructure but has control over operating systems, storage, deployed applications, and possibly limited control of select networking components (e.g., host firewalls).

Deployment Models are as follows:

Private cloud: the cloud infrastructure is operated solely for an organization. It may be managed by the organization or a third party and may exist on-premises or off-premises.

Community cloud: the cloud infrastructure is shared by several organizations and supports a specific community that has shared concerns (e.g., mission, security requirements, policy, and compliance considerations). It may be managed by the organizations or a third party and may exist on-premises or off-premises.

Public cloud: the cloud infrastructure is made available to the general public or a large industry group and is owned by an organization selling cloud services.

Hybrid cloud: the cloud infrastructure is a composition of two or more clouds (private, community, or public) that remain unique entities but are bound together by standardized or proprietary technology that enables data and application portability (e.g., cloud bursting for load balancing between clouds).

A cloud computing environment is service oriented with a focus on statelessness, low coupling, modularity, and semantic interoperability. At the heart of cloud computing is an infrastructure comprising a network of interconnected nodes.

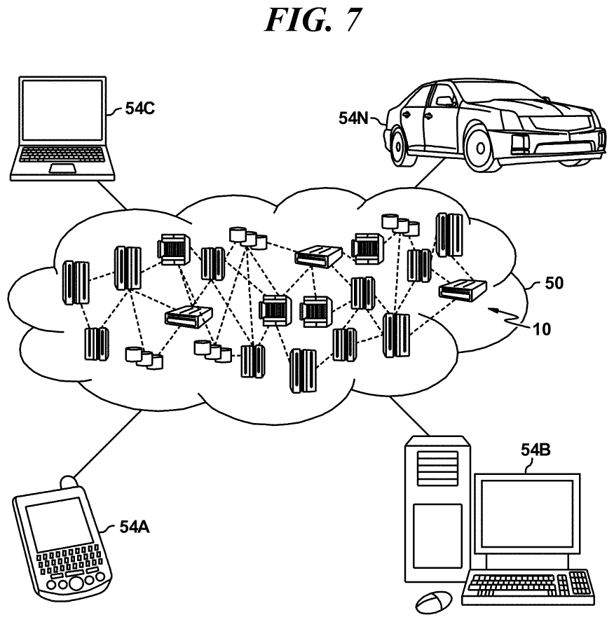

Referring now to FIG. 7, illustrative cloud computing environment 50 is depicted. As shown, cloud computing environment 50 includes one or more cloud computing nodes 10 with which local computing devices used by cloud consumers, such as, for example, personal digital assistant (PDA) or cellular telephone 54A, desktop computer 54B, laptop computer 54C, and/or automobile computer system 54N may communicate. Nodes 10 may communicate with one another. They may be grouped (not shown) physically or virtually, in one or more networks, such as Private, Community, Public, or Hybrid clouds as described hereinabove, or a combination thereof. This allows cloud computing environment 50 to offer infrastructure, platforms and/or software as services for which a cloud consumer does not need to maintain resources on a local computing device. It is understood that the types of computing devices 54A-N shown in FIG. 7 are intended to be illustrative only and that computing nodes 10 and cloud computing environment 50 can communicate with any type of computerized device over any type of network and/or network addressable connection (e.g., using a web browser).

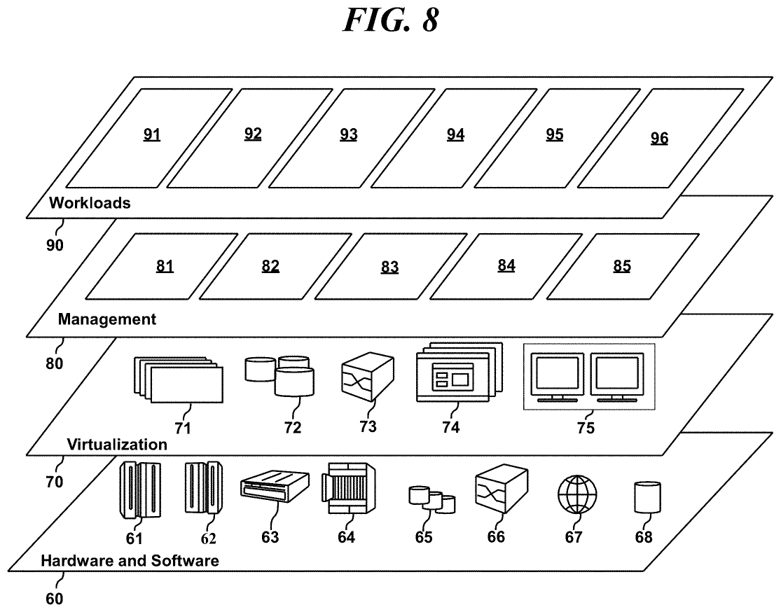

Referring now to FIG. 8, a set of functional abstraction layers provided by cloud computing environment 50 (FIG. 7) is shown. It should be understood in advance that the components, layers, and functions shown in FIG. 8 are intended to be illustrative only and embodiments of the invention are not limited thereto. As depicted, the following layers and corresponding functions are provided:

Hardware and software layer 60 includes hardware and software components. Examples of hardware components include: mainframes 61; RISC (Reduced Instruction Set Computer) architecture based servers 62; servers 63; blade servers 64; storage devices 65; and networks and networking components 66. In some embodiments, software components include network application server software 67 and database software 68.

Virtualization layer 70 provides an abstraction layer from which the following examples of virtual entities may be provided: virtual servers 71; virtual storage 72; virtual networks 73, including virtual private networks; virtual applications and operating systems 74; and virtual clients 75.

In one example, management layer 80 may provide the functions described below. Resource provisioning 81 provides dynamic procurement of computing resources and other resources that are utilized to perform tasks within the cloud computing environment. Metering and Pricing 82 provide cost tracking as resources are utilized within the cloud computing environment, and billing or invoicing for consumption of these resources. In one example, these resources may include application software licenses. Security provides identity verification for cloud consumers and tasks, as well as protection for data and other resources. User portal 83 provides access to the cloud computing environment for consumers and system administrators. Service level management 84 provides cloud computing resource allocation and management such that required service levels are met. Service Level Agreement (SLA) planning and fulfillment 85 provide pre-arrangement for, and procurement of, cloud computing resources for which a future requirement is anticipated in accordance with an SLA.

Workloads layer 90 provides examples of functionality for which the cloud computing environment may be utilized. Examples of workloads and functions which may be provided from this layer include: mapping and navigation 91; software development and lifecycle management 92; virtual classroom education delivery 93; data analytics processing 94; transaction processing 95; and at least a portion of software tool for development of generalizable models for classification tasks in sequential datasets 96.

The methodologies of embodiments of the disclosure may be particularly well-suited for use in an electronic device or alternative system. Accordingly, embodiments of the present invention may take the form of an entirely hardware embodiment or an embodiment combining software and hardware aspects that may all generally be referred to herein as a “processor,” “circuit,” “module” or “system.”

Furthermore, it should be noted that any of the methods described herein can include an additional step of providing a computer system for organizing and servicing resources of the computer system. Further, a computer program product can include a tangible computer-readable recordable storage medium with code adapted to be executed to carry out one or more method steps described herein, including the provision of the system with the distinct software modules.

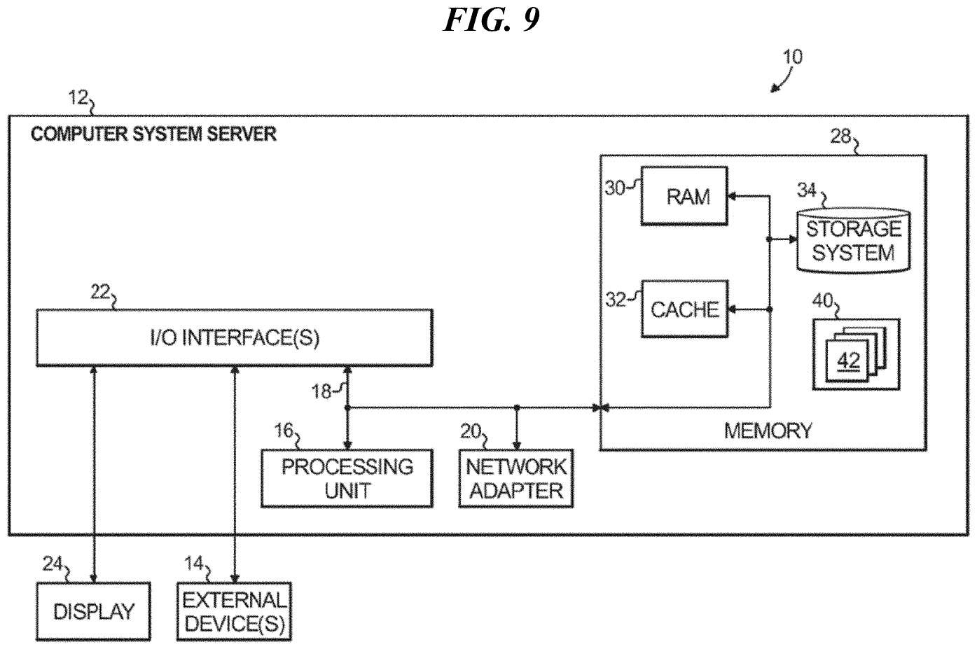

One or more embodiments of the invention, or elements thereof, can be implemented in the form of an apparatus including a memory and at least one processor that is coupled to the memory and operative to perform exemplary method steps. FIG. 9 depicts a computer system that may be useful in implementing one or more aspects and/or elements of the invention, also representative of a cloud computing node according to an embodiment of the present invention. Referring now to FIG. 9, cloud computing node 10 is only one example of a suitable cloud computing node and is not intended to suggest any limitation as to the scope of use or functionality of embodiments of the invention described herein. Regardless, cloud computing node 10 is capable of being implemented and/or performing any of the functionality set forth hereinabove.

In cloud computing node 10 there is a computer system/server 12, which is operational with numerous other general purpose or special purpose computing system environments or configurations. Examples of well-known computing systems, environments, and/or configurations that may be suitable for use with computer system/server 12 include, but are not limited to, personal computer systems, server computer systems, thin clients, thick clients, handheld or laptop devices, multiprocessor systems, microprocessor-based systems, set top boxes, programmable consumer electronics, network PCs, minicomputer systems, mainframe computer systems, and distributed cloud computing environments that include any of the above systems or devices, and the like.

Computer system/server 12 may be described in the general context of computer system executable instructions, such as program modules, being executed by a computer system. Generally, program modules may include routines, programs, objects, components, logic, data structures, and so on that perform particular tasks or implement particular abstract data types. Computer system/server 12 may be practiced in distributed cloud computing environments where tasks are performed by remote processing devices that are linked through a communications network. In a distributed cloud computing environment, program modules may be located in both local and remote computer system storage media including memory storage devices.

As shown in FIG. 9, computer system/server 12 in cloud computing node 10 is shown in the form of a general-purpose computing device. The components of computer system/server 12 may include, but are not limited to, one or more processors or processing units 16, a system memory 28, and a bus 18 that couples various system components including system memory 28 to processor 16.

Bus 18 represents one or more of any of several types of bus structures, including a memory bus or memory controller, a peripheral bus, an accelerated graphics port, and a processor or local bus using any of a variety of bus architectures. By way of example, and not limitation, such architectures include Industry Standard Architecture (ISA) bus, Micro Channel Architecture (MCA) bus, Enhanced ISA (EISA) bus, Video Electronics Standards Association (VESA) local bus, and Peripheral Component Interconnect (PCI) bus.

Computer system/server 12 typically includes a variety of computer system readable media. Such media may be any available media that is accessible by computer system/server 12, and it includes both volatile and non-volatile media, removable and non-removable media.

System memory 28 can include computer system readable media in the form of volatile memory, such as random access memory (RAM) 30 and/or cache memory 32. Computer system/server 12 may further include other removable/non-removable, volatile/non-volatile computer system storage media. By way of example only, storage system 34 can be provided for reading from and writing to a non-removable, non-volatile magnetic media (not shown and typically called a “hard drive”). Although not shown, a magnetic disk drive for reading from and writing to a removable, non-volatile magnetic disk (e.g., a “floppy disk”), and an optical disk drive for reading from or writing to a removable, non-volatile optical disk such as a CD-ROM, DVD-ROM or other optical media can be provided. In such instances, each can be connected to bus 18 by one or more data media interfaces. As will be further depicted and described below, memory 28 may include at least one program product having a set (e.g., at least one) of program modules that are configured to carry out the functions of embodiments of the invention.

Program/utility 40, having a set (at least one) of program modules 42, may be stored in memory 28 by way of example, and not limitation, as well as an operating system, one or more application programs, other program modules, and program data. Each of the operating system, one or more application programs, other program modules, and program data or some combination thereof, may include an implementation of a networking environment. Program modules 42 generally carry out the functions and/or methodologies of embodiments of the invention as described herein.

Computer system/server 12 may also communicate with one or more external devices 14 such as a keyboard, a pointing device, a display 24, etc.; one or more devices that enable a user to interact with computer system/server 12; and/or any devices (e.g., network card, modem, etc.) that enable computer system/server 12 to communicate with one or more other computing devices. Such communication can occur via Input/Output (I/O) interfaces 22. Still yet, computer system/server 12 can communicate with one or more networks such as a local area network (LAN), a general wide area network (WAN), and/or a public network (e.g., the Internet) via network adapter 20. As depicted, network adapter 20 communicates with the other components of computer system/server 12 via bus 18. It should be understood that although not shown, other hardware and/or software components could be used in conjunction with computer system/server 12. Examples, include, but are not limited to: microcode, device drivers, redundant processing units, and external disk drive arrays, RAID systems, tape drives, and data archival storage systems, etc.

Thus, one or more embodiments can make use of software running on a general purpose computer or workstation. With reference to FIG. 9, such an implementation might employ, for example, a processor 16, a memory 28, and an input/output interface 22 to a display 24 and external device(s) 14 such as a keyboard, a pointing device, or the like. The term “processor” as used herein is intended to include any processing device, such as, for example, one that includes a CPU (central processing unit) and/or other forms of processing circuitry. Further, the term “processor” may refer to more than one individual processor. The term “memory” is intended to include memory associated with a processor or CPU, such as, for example, RAM (random access memory) 30, ROM (read only memory), a fixed memory device (for example, hard drive 34), a removable memory device (for example, diskette), a flash memory and the like. In addition, the phrase “input/output interface” as used herein, is intended to contemplate an interface to, for example, one or more mechanisms for inputting data to the processing unit (for example, mouse), and one or more mechanisms for providing results associated with the processing unit (for example, printer). The processor 16, memory 28, and input/output interface 22 can be interconnected, for example, via bus 18 as part of a data processing unit 12. Suitable interconnections, for example via bus 18, can also be provided to a network interface 20, such as a network card, which can be provided to interface with a computer network, and to a media interface, such as a diskette or CD-ROM drive, which can be provided to interface with suitable media.

Accordingly, computer software including instructions or code for performing the methodologies of the invention, as described herein, may be stored in one or more of the associated memory devices (for example, ROM, fixed or removable memory) and, when ready to be utilized, loaded in part or in whole (for example, into RAM) and implemented by a CPU. Such software could include, but is not limited to, firmware, resident software, microcode, and the like.

A data processing system suitable for storing and/or executing program code will include at least one processor 16 coupled directly or indirectly to memory elements 28 through a system bus 18. The memory elements can include local memory employed during actual implementation of the program code, bulk storage, and cache memories 32 which provide temporary storage of at least some program code in order to reduce the number of times code must be retrieved from bulk storage during implementation.

Input/output or I/O devices (including but not limited to keyboards, displays, pointing devices, and the like) can be coupled to the system either directly or through intervening I/O controllers.

Network adapters 20 may also be coupled to the system to enable the data processing system to become coupled to other data processing systems or remote printers or storage devices through intervening private or public networks. Modems, cable modem and Ethernet cards are just a few of the currently available types of network adapters.

As used herein, including the claims, a “server” includes a physical data processing system (for example, system 12 as shown in FIG. 9) running a server program. It will be understood that such a physical server may or may not include a display and keyboard.

One or more embodiments can be at least partially implemented in the context of a cloud or virtual machine environment, although this is exemplary and non-limiting. Reference is made back to FIGS. 4-5 and accompanying text. Consider, e.g., a database app in layer 66.

It should be noted that any of the methods described herein can include an additional step of providing a system comprising distinct software modules embodied on a computer readable storage medium; the modules can include, for example, any or all of the appropriate elements depicted in the block diagrams and/or described herein; by way of example and not limitation, any one, some or all of the modules/blocks and or sub-modules/sub-blocks described. The method steps can then be carried out using the distinct software modules and/or sub-modules of the system, as described above, executing on one or more hardware processors such as 16. Further, a computer program product can include a computer-readable storage medium with code adapted to be implemented to carry out one or more method steps described herein, including the provision of the system with the distinct software modules.

One example of user interface that could be employed in some cases is hypertext markup language (HTML) code served out by a server or the like, to a browser of a computing device of a user. The HTML is parsed by the browser on the user's computing device to create a graphical user interface (GUI).

The present invention may be a system, a method, and/or a computer program product at any possible technical detail level of integration. The computer program product may include a computer readable storage medium (or media) having computer readable program instructions thereon for causing a processor to carry out aspects of the present invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, configuration data for integrated circuitry, or either source code or object code written in any combination of one or more programming languages, including an object oriented programming language such as Smalltalk, C++, or the like, and procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products ac-cording to various embodiments of the present invention. In this regard, each block in the flowchart or block diagrams may represent a module, segment, or portion of instructions, which comprises one or more executable instructions for implementing the specified logical function(s). In some alternative implementations, the functions noted in the blocks may occur out of the order noted in the Figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

The terminology used herein is for the purpose of describing particular embodiments only and is not intended to be limiting of the invention. As used herein, the singular forms “a,” “an” and “the” are intended to include the plural forms as well, unless the context clearly indicates other-wise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

The corresponding structures, materials, acts, and equivalents of all means or step plus function elements in the claims below are intended to include any structure, material, or act for performing the function in combination with other claimed elements as specifically claimed. The descriptions of the various embodiments of the present invention have been presented for purposes of illustration, but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

What is claimed is:

1. A method of generating a machine learning model for classifying sequential data, the method comprising:
receiving the sequential data, wherein the sequential data comprises a plurality of records having a plurality of features in a plurality of environments;
initializing a set of mask weights on the features;
initializing a set of classifier weights on the features;
processing, iteratively, a plurality of frames of the sequential data using the machine learning model comprising the mask weights and the classifier weights, wherein at each iteration the processing comprises:
generating a current one of the frames of the sequential data;
computing a penalty term over a data space of the current frame; and
updating the mask weights using the classifier weights on the features and the penalty term; and
outputting the machine learning model including updated ones of the mask weights to a service for performing a classification task based on a detection of at least one of the features in test data.

2. The method of claim 1, wherein: the data space of the current frame is an entire data space of the current frame, the method includes no assumption on a degree of invariance of the mask weights, and the machine learning model is one of an existing model and a newly instantiated model.

3. The method of claim 1, wherein the method includes no assumption on whether each instance of a given one of the features is invariant or spurious and no labeled data about the environments.

4. The method of claim 1, wherein a number of iterations, s, is pre-defined for the processing of the frames.

5. The method of claim 1, wherein computing the penalty term over the data space of the current frame further comprises:
computing a penalty loss term over the data space of the current frame of the classifier weights across the current frame; and
computing a total loss as a function of a prediction error for the mask weights on the features of the current frame and the penalty loss,
wherein the method further comprises:
determining a variance of the classifier weights on the features of the current frame, and wherein the updating of the mask weights increases the mask weights of invariant ones of the features according to the variance.

6. The method of claim 1, wherein computing the penalty term over the data space of the current frame further comprises:
computing a penalty loss term over the data space of the current frame of the classifier weights across the current frame; and
computing a total loss as a function of a prediction error for the mask weights on the features of the current frame and the penalty loss,
wherein the method further comprises:
determining a variance of the classifier weights on the features of the current frame, and
wherein the updating of the mask weights decreases the mask weights of spurious ones of the features according to the variance.

7. The method of claim 1, wherein the test data includes a text corpus of documents, and wherein the classification task comprises:
processing each of the documents using the machine learning model to identify instances of the features in each of the documents;
classifying each of the documents according to respective ones of the identified instances of the features; and
adding an indication of the respective classifications to each of the documents.

8. The method of claim 1, wherein the test data includes a document, and the classification task comprises:
processing the document using the machine learning model to identify instances of the features in the document;
identifying a sentiment for each of a plurality of portions of the document according to corresponding ones of the identified instances of the features; and
adding an indication of the sentiments to the document.

9. The method of claim 1, further comprising receiving the test data from at least one sensor and the classification task comprises processing the test data received from the at least one sensor using the machine learning model, wherein the machine learning model detects at least one event in the data.

10. The method of claim 9, wherein the at least one sensor includes an accelerometer and a gyroscope, and the at least one event is a selected from at least one of a walking event, a walking upstairs event, a walking downstairs event, a sitting event, a standing event, and a laying down event.

11. A computer readable medium comprising computer executable instructions which when executed by a computer system cause the computer to perform a method for generating a machine learning model for classifying sequential data, the method comprising:
accessing the sequential data, wherein the sequential data comprises a plurality of records having a plurality of features in a plurality of environments;
initializing a set of mask weights on the features;
initializing a set of classifier weights on the features;
processing, iteratively, a plurality of frames of the sequential data using the machine learning model comprising the mask weights and the classifier weights, wherein at each iteration the processing comprises:
generating a current one of the frames of the sequential data;
computing a penalty term over a data space of the current frame; and
updating the mask weights using the mean and the variance of the classifier weights on the features and the penalty term; and
outputting the machine learning model including updated ones of the mask weights to a service for performing a classification task based on a detection of at least one of the features in test data.

12. The computer readable medium of claim 11, wherein: the data space of the current frame is an entire data space of the current frame, the method includes no assumption on a degree of invariance of the mask weights and the machine learning model is one of an existing model and a newly instantiated model.

13. The computer readable medium of claim 11, wherein the method includes no assumption on whether each instance of a given one of the features is invariant or spurious and no labeled data about the environments.

14. The computer readable medium of claim 11, wherein a number of iterations, s, is pre-defined for the processing of the frames.

15. The computer readable medium of claim 11, wherein computing the penalty term over the data space of the current frame further comprises:
computing a penalty loss term over the data space of the current frame of the classifier weights across the current frame; and
computing a total loss as a function of a prediction error for the mask weights on the features of the current frame and the penalty loss,
wherein the method further comprises:
determining a variance of the classifier weights on the features of the current frame, and
wherein the updating of the mask weights increases the mask weights of invariant ones of the features according to the variance.

16. The computer readable medium of claim 11, wherein computing the penalty term over the data space of the current frame further comprises:
computing a penalty loss term over the data space of the current frame of the classifier weights across the current frame; and
computing a total loss as a function of a prediction error for the mask weights on the features of the current frame and the penalty loss,
wherein the method further comprises:
determining a variance of the classifier weights on the features of the current frame, and
wherein the updating of the mask weights decreases the mask weights of spurious ones of the features according to the variance.

17. The computer readable medium of claim 11, wherein the test data includes a text corpus of documents, and wherein the classification task comprises:
processing each of the documents using the machine learning model to identify instances of the features in each of the documents;
classifying each of the documents according to respective ones of the identified instances of the features; and
adding an indication of the respective classifications to each of the documents.

18. The computer readable medium of claim 11, wherein the test data includes a document, and the classification task comprises:
processing the document using the machine learning model to identify instances of the features in the document;
identifying a sentiment for each of a plurality of portions of the document according to corresponding ones of the identified instances of the features; and
adding an indication of the sentiments to the document.

19. The computer readable medium of claim 11, further comprising receiving the test data from at least one sensor and the classification task comprises processing the test data received from the at least one sensor using the machine learning model, wherein the machine learning model detects at least one event in the data.

20. The computer readable medium of claim 19, wherein the at least one sensor includes an accelerometer and a gyroscope, and the at least one event is a selected from at least one of a walking event, a walking upstairs event, a walking downstairs event, a sitting event, a standing event, and a laying down event.
